(19) United States
(12) Patent Application Publication
(10) Pub. No.: US 2004/0221023 A1
(43) Pub. Date: Nov. 4, 2004

(54) Remote registration method and program and remote registration system

(75) Inventors: Jun Sasano, Tokyo (JP); Tsuneo Kohari, Mishima-shi (JP); Osamu Tachiyama, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/787,829

(22) Filed: Feb. 27, 2004

(30) Foreign Application Priority Data
Feb. 28, 2003 (JP) 2003-054407

(51) Int. Cl. G06F 15/177; G06F 15/16

(52) U.S. Cl. 709/220; 709/249

(57) ABSTRACT

A remote registration method comprises causing an MFP (Multifunctional Peripheral device) to inquire a server installed outside an intranet about the presence/absence of data to be registered on the MFP; when the data is present, causing the MFP to request transfer of the data from an intraserver in the intranet; detecting the presence/absence of the data in the intraserver on the basis of the transfer request; when the data is absent in the intraserver, transferring the data from the server to the intraserver through a firewall and storing the data; and when the data is present in the intraserver, transferring the data from the intraserver to the MFP.

### CROSS-REFERENCE TO RELATED APPLICATIONS

This application is based upon and claims the benefit of priority from the prior Japanese Patent Application No. 2003-54407, filed Feb. 28, 2003, the entire contents of which are incorporated herein by reference.

### BACKGROUND OF THE INVENTION

1. Field of the Invention

The present invention relates to a remote registration method and program and a remote registration system which transfer firmware or the like from a server arranged outside an intranet to a device in the intranet through a firewall device and register the firmware or the like and, more particularly, to a remote registration method and program and a remote registration system which can improve data transfer efficiency.

2. Description of the Related Art

Business machines such as an MFP (multifunctional peripheral device) and a copying machine which are concentrically controlled by being connected to an intranet installed in a company or the like are known (see Patent Document 1).

As described above, in the business machine, periodically or as needed, the server installed outside the intranet is inquired about setting information or firmware. If there is a data to be downloaded (transferred), the data is downloaded from the external server through the Internet.

The conventional data transfer method described above causes the following problems. More specifically, a firewall device is generally arranged between the intranet and the Internet to assure the security in the company. For this reason, even though data can be transferred through the intranet or the Internet at a high speed, it is functionally difficult to increase the speed of the firewall device. Therefore, a long time may be required to transfer a large quantity of data. In addition, since the firewall device is occupied for a long period of time, trouble occurs when another device accesses the Internet, or an external server is disadvantageously heavily loaded.

### BRIEF SUMMARY OF THE INVENTION

It is an object of the present invention to provide a remote registration method and program and a remote registration device which can efficiently transfer even a large quantity of data when a device connected to an intranet transfers data from an external server through the firewall device.

A remote registration method which transfers data to be registered on a device in an intranet from a server outside the intranet to the device through a firewall device and registers the data on the device includes: a step of causing the device to inquire the server about the presence/absence of the data; a step of, when the data is present, causing the device to request transfer of the data from an intraserver in the intranet; a step of detecting the presence/absence of the data in the intraserver on the basis of the transfer request; a step of, when the data is absent in the intraserver, causing the intraserver to transfer the data from the server to the intraserver and to store the data; and a step of, when the data is present in the intraserver, transferring the data from the intraserver to the device.

When the device connected to the intranet transfers data from the external server through the firewall device, the data can be efficiently transferred even though the data is a large quantity of data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a system to perform a remote registration method according to an embodiment of the present invention.

FIG. 2 is a diagram for explaining steps in the remote registration method.

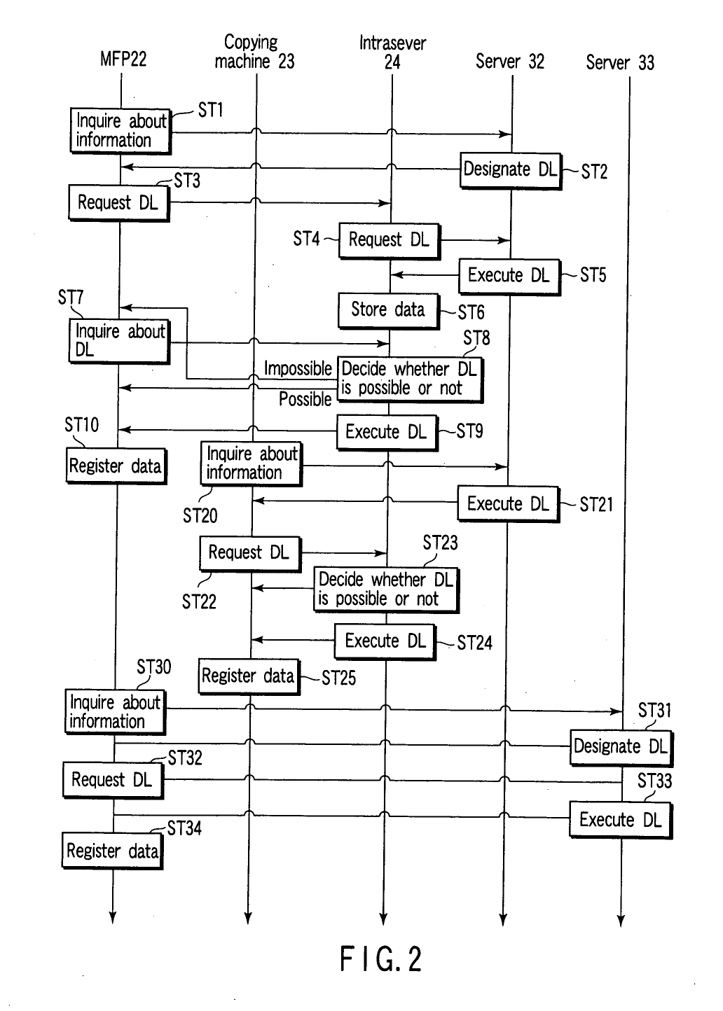

### DETAILED DESCRIPTION OF THE INVENTION

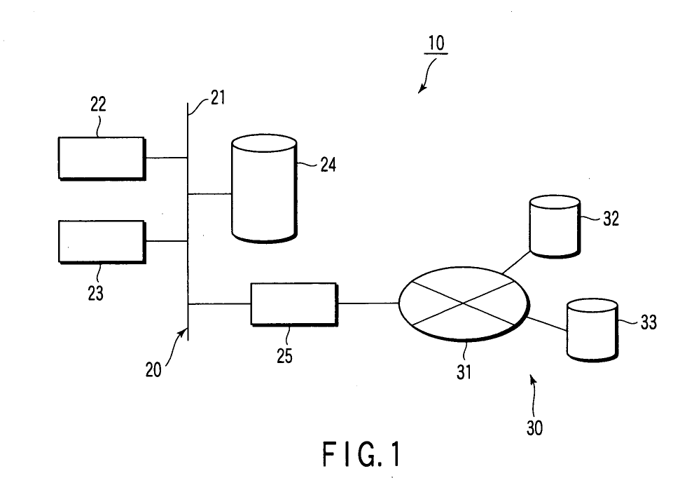

FIG. 1 is a diagram showing a system 10 which performs a remote registration according to an embodiment of the present invention. The system 10 is constituted by a network system 20 arranged in a company and an external network system 30 connected to the network system 20.

The network system 20 comprises an intranet 21. An MFP (remote registration device) 22, a copying machine (remote registration device) 23, an intraserver 24, and a firewall device 25 which monitors exchanges of data with an external device are connected to the intranet 21. The MFP 22 and the copying machine 23 each have a function which transmits a transmit designation signal to an intraserver 24 (to be described later) or external servers 32 and 33 to perform download or the like of data. The intraserver 24 comprises a storage device which stores data.

In an external network system 30, a communication circuit 31 such as the Internet, a server 32 which provides firmware (data), and a server 33 which provides setting information (data) are connected.

In the system 10 having the above configuration, the firmware and the setting information are transferred to the copying machines 22 and 23 in the network system 20 by the following manner. First, a case in which firmware is transferred will be described below. The MFP 22 inquires the server 32 about the presence/absence of firmware and quantity information periodically or as needed, (ST1). The server 32 transmits the download designation and the quantity information of the firmware to the MFP 22 when new firmware is present on the basis of the inquiry (ST2). The MFP 22 requests the intraserver 24 to download the data on the basis of the download designation and the quantity information. Although the MFP 22 requests the intraserver 24 to download the data, the intraserver 24 or the server 32 is determined as a target which is requested to download the data depending on the quantity of the firmware. For example, the quantity is 1 MB or more, the target which is requested to download the data is determined as the intraserver 24.

The intraserver 24 requests the server 32 to download data (ST4). In the server 32, the firmware is downloaded on the intraserver 24 on the basis of the download request from the intraserver 24 (ST5), and the data is stored in the intraserver 24 (ST6).

The MFP 22 inquires the intraserver 24 about download (ST7). When the download in step ST5 is not completed, the intraserver 24 gives a reply as “download is impossible” and waits. When the download is completed, and the intraserver 24 gives a reply as “download is possible” and shifts to step ST9 (ST8). The firmware is downloaded from the intraserver 24 onto the copying machine 22 (ST9), and the registration is ended (ST10).

The copying machine 23 inquires the server 32 about the presence/absence of firmware (ST20). When there is new firmware on the basis of the inquiry, the server 32 transmits a download designation to the copying machine 23 (ST21). The copying machine 23 requests the intraserver 24 to download the firmware on the basis of the download designation (ST22). The intraserver 24 detects whether the firmware is stored in the intraserver 24 or not (ST23). Since the firmware has been stored in the intraserver 24, the firmware is downloaded from the intraserver 24 onto the copying machine 23 without requesting the server 32 to download the firmware (ST24), and the registration is ended (ST25).

On the other hand, in case of setting information, the MFP 22 inquires the server 33 (ST30). The server 33 transmits a download designation and quantity information of setting information data to the MFP 22 (ST31). At this time, when the quantity of the setting information data is, e.g., 1 MB or less, the MFP 22 directly transmits a download request to the server 33 (ST32). General setting information data has several KB or less. When data having small quantity, i.e., 1 MB or less is used, time for occupying the firewall device 25 is short, and trouble rarely occurs.

The server 33 downloads the setting information data on the MFP 22 on the basis of the download request (ST33), and the registration is ended (ST34).

As described above, a large quantity of data such as firmware passes through the firewall device 25 and is stored in the intraserver 24 for only the first time. For the second and subsequent times, the firewall is transferred from the intraserver 24, i.e., the firewall is transferred in the network system 20. For this reason, transfer efficiency can be improved. Since time for occupying the firewall device 25 can be made minimum, trouble can be suppressed from occurring when another device accesses an external network. In addition, since the number of download request from the server 32 decreases, load on the server 33 can be reduced. A small quantity of data such as setting information may be directly downloaded from the external server 33 as in a prior art.

The present invention is not limited to the above embodiment. In the above example, although firmware is used, a telephone number list or a program for upgrading a version may be used. Furthermore, the reference of quantity for deciding whether download is performed through the intraserver 24 or not is set at 1 MB. However, the reference may be properly changed depending on the status of the entire network. In addition, not only quantity but also another condition such as a time zone can be used as the reference. Various changes and modifications can be effective without departing from the spirit and scope of the invention as a matter of course.

This embodiment describes the case in which the functions of the invention are stored in the system. However, the invention is not limited to the above configuration. That is, the same functions may be downloaded from a network, and a recording medium in which the same functions are stored may be installed in the system. As the recording medium a floppy disk, any computer readable recording medium such as a hard disk, an optical disk (CD-ROM or the like), a magneto-optical disk (MO or the like), or a semiconductor memory can be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A remote registration method comprising:
causing a device in an intranet to inquire the server installed outside the intranet about the presence/absence of data to be registered on the device;
when the data is present, causing the device to request transfer of the data from an intraserver in the intranet;
detecting the presence/absence of the data in the intraserver on the basis of the transfer request;
when the data is absent in the intraserver, transferring the data from the server to the intraserver through a firewall device and storing the data; and
when the data is present in the intraserver, transferring the data from the intraserver to the device.

2. The remote registration method according to claim 1, wherein
the data is data having quantity which is not less than predetermined quantity.

3. A remote registration method comprising:
causing a device in an intranet to inquire a server installed outside the intranet about the presence/absence of data to be registered on the device and quantity information;
when the quantity of the data is smaller than predetermined quantity, causing the device to request direct transfer the data through a firewall device from the server, and, when the quantity of the data is not less than the predetermined quantity, causing the device to request transfer of the data from a server in the intranet; and
storing data transferred on the basis of the request made in the step of making the request.

4. The remote registration method according to claim 3, wherein
the data is firmware.

5. A program for operating a computer, comprising:
a function of causing a device in an intranet to inquire a server installed outside the intranet connected through a firewall device about the presence/absence of data to be registered on the device;
a function of, when the data is present, causing the device to request transfer of the data from an intraserver in the intranet; and
a function of detecting the presence/absence of the data in the intraserver on the basis of the transfer request;
a function of, when the data is absent in the intraserver, causing the intraserver to transfer the data from the server to the intraserver; and
a function of, when the data is present in the intraserver, transferring the data from the intraserver to the device.

6. The program according to claim 5, wherein
the data is data having quantity which is not less than predetermined quantity.

7. A remote registration system in an intranet connected to a server installed outside the intranet through a firewall device, comprising:
a storage which stores a data;
an inquiry device which inquires the server installed outside the intranet about the presence/absence of data to be registered on the storage means;
a transfer requesting device, when the data is present, which requests an intraserver in the intranet to transfer the data;
a detecting device which detects the presence/absence of the data in the intraserver on the basis of the transfer request;
a storage designation device, when the data is absent in the intraserver, which transfers the data from the server to the intraserver and storing the data; and
a transferring device, when the data is present in the intraserver, which transfers the data from the intraserver to the storage means.

8. The remote registration system according to claim 7, wherein
the data is data having quantity which is not less than predetermined quantity.
